(19) United States
(12) Patent Application Publication
(10) Pub. No.: US 2012/0289323 A1
(43) Pub. Date: Nov. 15, 2012

(54) METHOD AND SYSTEM FOR INTERACTIVE FANTASY GAMBLING CONTEST

(76) Inventor: Michael C. Whitmire, Los Angeles, CA (US)

(21) Appl. No.: 13/470,110

(22) Filed: May 11, 2012

Related U.S. Application Data
(60) Provisional application No. 61/485,351, filed on May 12, 2011.

(51) Int. Cl. G06F 17/00; A63F 9/24

(52) U.S. Cl. 463/26; 463/42

(57) ABSTRACT

A server hosting a website and method thereto for managing an interactive system for a plurality of users connected via a communication network, wherein each user may play as a bettor and/or as a bookie on a real life scheduled competition, such as a sporting event. The user who is assigned to play as the bookie in the scheduled competition is responsible for setting the odds for the scheduled competition. Information may be provided to the plurality of users for assisting users with both making a wager and for setting the odds for their assigned scheduled competition. The results of the wagers are based on the outcomes of the scheduled competition, and the users are ranked and compensated accordingly.

### CROSS-REFERENCE TO RELATED APPLICATIONS

This application claims priority from U.S. Provisional Application Ser. No. 61485351 filed on May 12, 2011, the disclosure of which is incorporated by reference herein in its entirety.

### FIELD OF THE INVENTION

The present invention generally relates to interactive online websites and methods using them, and more specifically relates to websites in which a plurality of users that connected via a communication network can compete by making wagers.

### BACKGROUND

Online gambling and sports betting have become widespread. Americans bet more than $100 billion annually with offshore Internet gambling firms. Still, many people avoid or do not consider sports betting due to the heavy stigma and legal risk and restrictions surrounding gambling.

Similar to sports betting, “Fantasy Sports” makes up another popular wing of sports entertainment. Fantasy Sports are games driven by the Internet and typically include game players selecting a team of players in a particular sport and using the real life statistics of the players of their team to play against other selected teams. They are estimated to have a $3-$4 billion annual economic impact across the sports industry. A projected 32 million people in the United States and Canada play these games. There is a similarity between the field of sports betting and the field of Fantasy Sports, participants in both fields have rooting interest in some actual competition. Both fields are based on actual competitions, and the thrill of playing both is the predictive awareness the participant has that he/she is correct about the outcome. Because actual player statistics underlie the final scores or outcomes of actual competitions, there is little separating a confidence in an actual player's ability to perform and a confidence that a given team will win.

Fantasy Sports allow participants to compete against friends or strangers with as few as two virtual teams in a so-called “Fantasy League.” Participants form their virtual sports teams by choosing from lists of actual players who are virtually “drafted” and “traded” on an Internet based game platform. By choosing actual players, participants are effectively voting for or rooting for their actual players to outperform the actual players belonging to their opponent. The performance of participants is in large part determined by the actual players. And actual players' statistics are accumulated by the virtual team in a series of sporting events, typically scheduled by a professional sports associations such as the NFL, MLB, NBA, NHL, PGA, or other sports association. Significantly, the success of Fantasy Sports proves that (a) sports fans are happy competing for mere bragging rights and (b) Fantasy League participants are comfortable coordinating prizes separate from the Internet based game platform.

Fantasy Sports is defined as a game of skill and has been exempted from the Unlawful Internet Gambling Enforcement Act of 2006 (UIGEA). The UIGEA explicitly exempts Fantasy Sports, educational games, or any online contest that “has an outcome that reflects the relative knowledge of the participants or their skill at physical reaction or physical manipulation (but not chance), and, in the case of a fantasy or simulation sports game, has an outcome that is determined predominantly by accumulated statistical results of sporting events, including any non-participant's individual performances in such sporting events . . . ” 31 USC 5361-5366 (2006). To be compliant with the Act, a Fantasy Sports game must follow the rule that: “prizes and awards offered to winning participants are established and made known to the participants in advance of the game or contest and their value is not determined by the number of participants or the amount of any fees paid by those participants.” 31 USC 5361-5366 (2006). Since passage of the Act, several United States based companies have started successful websites that allow Fantasy Sports participants to essentially bet on their virtual team's performance against an opponent.

An example of a website which provides prizes to winning participants is http://www.draftstreet.com/. Another related example is described in U.S. Patent Publication No. 2005/0049731 which is incorporated herein by reference. This document discloses a system and method for interactive wagering from a remote location. The disclosure discusses enabling wagering based on a deposit account, whereby funds are registered to an account number in advance of wagering taking place. The user can stake wagers up to the value held on deposit. However none of the websites known in the art enable their users to play the role of the bookie and to set the lines.

### SUMMARY OF THE DISCLOSURE

It is an object of the present invention to provide an interactive gaming website and method thereto for a plurality of users connected via a communication network, and to attract portions of the sports betting and Fantasy Sports markets.

It is another object of the present invention to provide an interactive gaming website and method thereto for a plurality of users connected via a communication network which capture the skills of betting and odds making.

It is still another object of the present invention to provide an interactive gaming website and method thereto for a plurality of users connected via a communication network to be characterized as a game of skill under the UIGEA or a similar Act passed by Congress, but not subject the prohibitions of the act, thus opening up further business opportunities.

Other objects of this invention will become clear as the description of the invention proceeds.

According to one embodiment of the present invention a method for managing an interactive online website is provided. First a plurality of users is registered to the website, and data associated with each registered user is stored in the memory of a server. The website retrieves information about coming sporting events from one or more data sources (e.g. league schedule, lines from reputable odds maker etc.). The website provides registered users with at least some of the information (e.g. the league schedule may be sent to the registered users by e-mail or just available to registered users at the website upon signing in). The website receives from a first user (the user that currently plays as the bookie) one or more lines associated with a coming sporting event, and from other registered users receives wagers associates with the one or more lines received from the first user. Based on the actual outcome of the sporting event the website determines the results of the wagers made by the registered users. Then according to results of the wagers the website compensates the first user who set the lines and/or the other registered users which made the wagers.

Other aspects and embodiments of this invention will become clear as the description of the invention proceeds.

### BRIEF DESCRIPTION OF THE DRAWINGS

For a more complete understanding of the present invention, reference is made to the following detailed description taken in conjunction with the accompanying drawings wherein:

FIG. 1—is a flowchart describing the process of an interactive wagering game according to an embodiment of the present invention;

FIG. 2—is a screenshot showing an example of what a user playing as a bettor may see prior to the beginning of the game;

FIG. 3—is a screenshot showing an example of what a user playing as a bettor may see after the end of the game;

FIG. 4—is a screenshot showing an example of a typical league games display;

FIG. 5—is a screenshot showing another example of a typical league games display;

FIGS. 6A and 6B—are two screenshots showing another typical league games display.

FIG. 7—is a screenshot in a continuation of the scenario described in FIG. 6B illustrating how a bookie can change the lines; and

FIGS. 8A, 8B and 8C—are screenshots illustrating how a bettor can place a bet.

### DETAILED DESCRIPTION

In the following description, for the purposes of explanation, numerous specific details are set forth in order to provide a thorough understanding of the present invention. It should be apparent, however, that the present invention may be practiced without these specific details.

With the increased use of smart-phones and wireless Internet access, Fantasy Sports and sports betting will only become more popular. People are finding new ways to instantly connect with friends, and Fantasy Sports are part of that trend. Faced with an over $1 trillion budget deficit, there is increased pressure on the federal government to loosen restrictions on gambling to avoid the billions of dollars currently lost to other countries. Based on the passage of the UIGEA, if online gambling is not legalized altogether, there is still a possibility that the federal government will allow cash to be exchanged on Internet sites offering games of skill. Most of all, the present invention is intended to be an entertaining and skillful game whose enjoyment is independent of any prize or award.

According to another embodiment upon registration each user is assigned with a user account and is credited with a predetermined number of game points. The present disclosure refers to wagers with game points and the option of prize or award to the users with the highest number of game points. However, as any person skilled in the art can grasp this invention can easily be modified for real money gambling, in case this option will be legal one day.

According to one embodiment of the invention, there are two roles which users can play, a “bettor” and a “bookie”. A user playing as “bettor” reviews the available bets and selects the bet he is interested in and the amount of game points he is willing to risk, this role is well known in the art. A user playing as a “bookie” actually set the lines/odds this role will be extensively described below. Each user may play as bettor or as a bookie or as both. The role of a bookie may be assigned at random, manually by the league's founder, or in some other way predetermined by either the league participants or league founder(s). The role of a bookie may also be an option that the user may selects.

The following example illustrates how a user playing as the bookie can set the lines according to one embodiment of the invention, and explain basic terms in the field of Sport gambling. In a National Football League (NFL), before Sundays, one user is assigned to play as the bookie at the Giants versus Patriots game. If the user playing the bookie believes the Giants will win by more than 4 points, he might set the odds as Giants −4 (Giants will win by or are favored to win by more than 4 points). This action called “setting the line”. In addition, if the user playing the bookie knows the biases of the public or users within the league, he can adjust the odds accordingly. Actual lines set by a reputable odds maker may be also available to the user playing the bookie for each assigned game. Assuming the user playing the bookie is provided with a line set by a reputable odds maker: Patriots −3 (i.e. Patriots are favored to win by more than 3 points), he may use this information in setting the line for his league. In case the user playing the bookie is aware that there are several Patriots fans amongst his league opponents, he might set the line as Giants −1.5, (Giants are favored to win by more than 1.5 points) because it will invite wagers from opponents who see the line as a good value. Half points are sometimes used in setting odds/lines to avoid a situation where the player neither wins their wager or losses it, this situation called a “push”. An example of a push is if the Giants are favored to win by 4 and actually win by 4. In that event, users who wagered on the outcome of that game are refunded.

As any person skilled in the art will understand there may be other factors beside the public bias, the user's own position in, and the provided line from a reputable odds maker that may influence the handicapping process of the user playing the bookie making a point spread. The term handicap generally means to analyze an event for gambling purposes, however it may also applied to the practice of predicting the result of a competition, such as for purposes of betting against a point spread.

The following is an example explains the term “point spread” and demonstrates one option for setting the line according to an embodiment of the invention. Using the same NFL game as above, the point spread that the user playing the bookie decided is:
Giants −4 (−105)
Patriots +2 (+115)

The point spread on this NFL game is −4 points chalk the Giants. This means that if a user bet the spread on the Giants, the Giants need to win the game by 5 points in order for the user bet to be a winner. As mentioned above If the Giants wins by 4 points, it is a push and no one wins or losses. In the example above, if the final score is Giants 27-Patriots 19 the Giants cover the point spread, since they won the game by 8 points (8>4). However, if the final score is Giants 25-Patriots 22, the Giants failed to cover the spread (3<4) and all the bets on the Giants are lost. This mean that even if favored team that wins but by in less than the point spread, the team might won the game, but the bets on that team are lost.

The second number in the bet which usually appears in parentheses is the “moneyline” and typically accompanies all handicap factors like a price tag. The moneyline is usually based on $100 (or 100 game points), when the moneyline is negative, it represents what a bettor would have to wager in order to win $100 (or 100 game points). When the moneyline is positive, it represents what the bettor would win if he/she wagered $100 (or 100 game points).

According to one embodiment of the invention, before the start of the sporting event (e.g. the Sunday's games), all or some of the users may choose to wager on the line(s) determined by the user playing as the bookie. The user playing as the bookie can view the wagers being placed on his line(s), and can adjust the line(s) accordingly until the start of the respective sporting event. According to one embodiment the users who participate as wagers can only view their own wager until the start of the game. Only when the wagering is closed all the wagers and the identity of their respective “bettors” for a particular game are revealed to the rest of the users. According to another embodiment, the users who participate as bettors can only view all the wagers and the identity of their respective bettors a predetermined time before the start of the game.

In the scenario that the final score is Giants 27-Patriots 19, the Giants in fact cover the point spread, the users accounts are credited or debited commensurate with their wagers. Users playing as bookies keep the balance of the total wagers. After the bet is done and the users accounts are credited or debited, the following are non-limiting examples for details the may be stored for each user playing as a bettor: account balance, gains and losses, record of the Wins-Losses-Pushes (W-L-P), win percentage and total currently wagered/at risk. According to one embodiment information regarding to the success of users playing as bookies may also be stored, the following are examples for details the may be stored for each user playing as a bookie: account balance, gains and losses, record (W-L-P), win percentage, and total currently wagered against.

Users that participant in a League may be ranked based on their total game points bankroll, reflecting the overall success of the participant as a bettor and gambler. According to a different embodiment the data of a user may be separated to bettor data and bookie data, and users may be ranked based on their overall success as a bettor or as a bookie. In addition, even if a user's total bankroll reaches zero, he/she may still has a competitive interest in the game as a bookie. Leagues can also coordinate prizes separate from the interactive Internet platform for best bettor, best bookie, etc.

According to one embodiment the system may also track the performances of users in other existing leagues. In the aforementioned categories (referred to as “community data”). For example, data is packaged as a “Bettor Leaderboard.” The system can sort the data according to sport, minimum number of bets, minimum win percentage, and minimum percentage gain. Data ranking other users is presented, showing overall league record, overall league win percentage, total bankroll for the particular league, win or losing streak (e.g. W4, L3), and record for last 10 wagers (W-L-P). A similar “Bookie Leaderboard” may be made available. All community data may be made available for free with commercial advertising or available exclusively for paying subscribers. According to one embodiment the system may provide a chat feature on every screen available to league participants. This embodiment enables a user playing as a bettor to chat with a user playing a bookie, and vice versa.

The present invention will be better understood and appreciated more fully when taken in conjunction with the accompanying drawings.

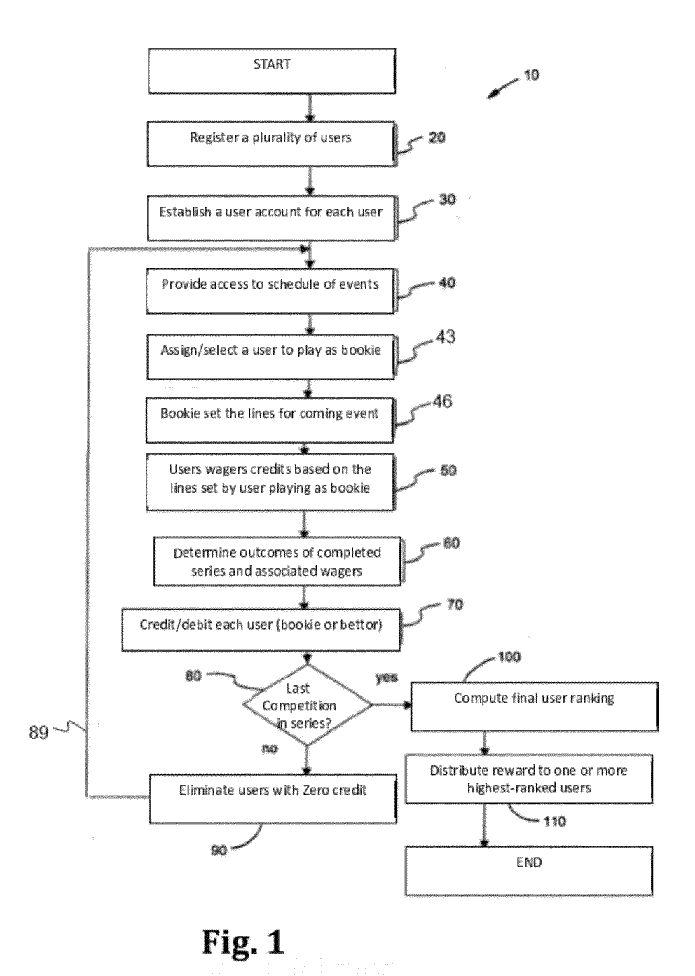

FIG. 1 is a flowchart which describes the process of an interactive wagering game according to embodiment of the present invention. The method (10) is particularly suited for play in an interactive Internet format whereby participants in various remote locations can participate together. In this method, game participants register (20) to compete against one another in an interactive wagering contest. A user registration fee may be collected from each participant using known electronic payment systems and methods. In addition, participants may be permitted to register to compete against a finite group of other known participants in a private group or “league”. After users register (20), a separate game account is established (30) wherein each user has a user account and is credited with equal number of game points. Users are provided access (40) to a schedule of upcoming sporting events on which the participants will be permitted to wager credits from their game accounts.

One or more users are assigned or select (43) to play as bookies for a specific sporting event in the schedule of upcoming competitions. The one or more bookies set the lines (46) according to any one of the factor described above or any combination thereof. From the schedule of next-scheduled competitions or games and the list of bets, participants are permitted to wager game points (50) from their accounts on one or more scheduled competitions in the series of competitions. Following completion of the last of the round of competitions or games in the series, the outcomes of all completed competitions are determined (60).

Based upon the determined competition outcomes, each participant account is credited or debited game points based on the result of each participant's wagers (70). In the case where the participate is a bookie credited or debited his account based on the wagers outcome for bets that he had set the lines for. If the prior round of completed competitions is not the last in the series of competitions (80), the play continues as described above for another round of next-scheduled competitions. This result is indicated by arrow (95) in FIG. 1.

A participant who unsuccessfully wagers all of his game points, or as a bookie he/her set the lines in such way that he/her lost all of his game points, is eliminated from further play. The process of setting the lines and wagering described above in steps (40)-(70) is repeated until the last competition or round of competitions in the series of competitions is completed. Once the results of a final round of wagers are determined, final user participant rankings are computed (100) based on the final number of game points in each participant's account. Final user participant rankings may be published, and the user with the highest final account balance is established as the overall contest winner. One or more prizes may be distributed (110) to the overall winner and/or to the best bookie and/or to the best bettor. Prizes may include cash, merchandise, or other valuable items, services, or benefits.

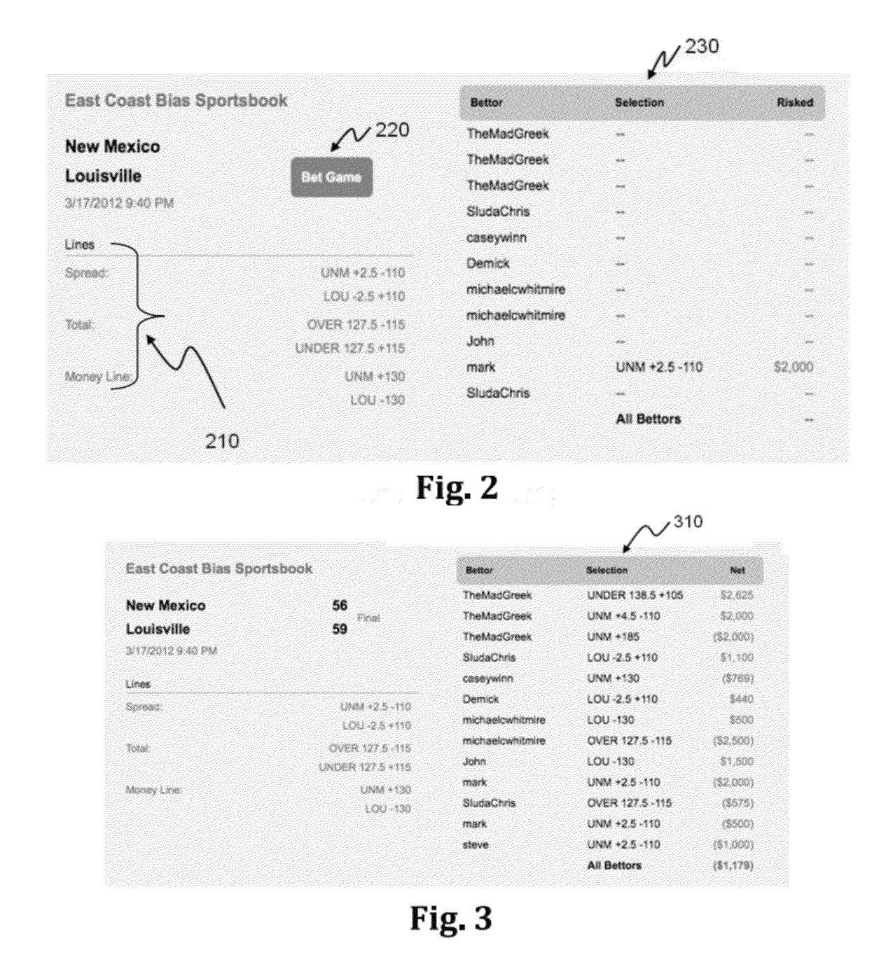

FIG. 2 is a screenshot showing an example of what a user playing as a bettor would see in a scheduled actual competition. The details are chosen from a schedule in a typical league, prior to the beginning of the game. The name of the bookie is displayed as “East Coast Bias”. The game chosen is New Mexico at Louisville. The date and start time of the game are listed, indicating when wagering will be closed. The lines (210) show that Louisville is favored to win by 2.5 points, other handicap factors, like the total number of points, and moneyline for the winner, have also been set by the bookie. A “Bet Game” button (220) is visible to those who may wager on the game. The table (230) displayed to the right of the handicap factors shows the league participants who have already placed wagers.

According to one embodiment the selection and amount(s) at risk are concealed until the start of the game. Each user who chooses to view the game details can only see his/her own wager. In this case, “mark” is the participant viewing and can see his wager of $2,000 on the underdog, New Mexico.

FIG. 3 is a screenshot showing an example of what a user playing as a bettor would see in the scheduled actual competition of FIG. 2 after to the end of the game. On the table (310) displayed to the right, note that “Net” now replaces where “Risk” (amount at risk) was shown in FIG. 2. The wagers of all the participants are displayed.

The wagers in parenthesis represent a loss to the respective bettor, and wagers not in parenthesis indicate a credit to the respective bettor.

The net total of wagers is awarded or deducted from the bookie's account. Here, the account of the bookie “East Coast Bias” would gain is $1,179, since the sum of all bettors outcome is −1,179. It is interesting to see that as a 2.5-point favorite, Louisville only beat the spread by a ½ point. Had the bookie set the line as Louisville favored to win by 3, those wagering on that line would have pushed, resulting in a refund of their wager.

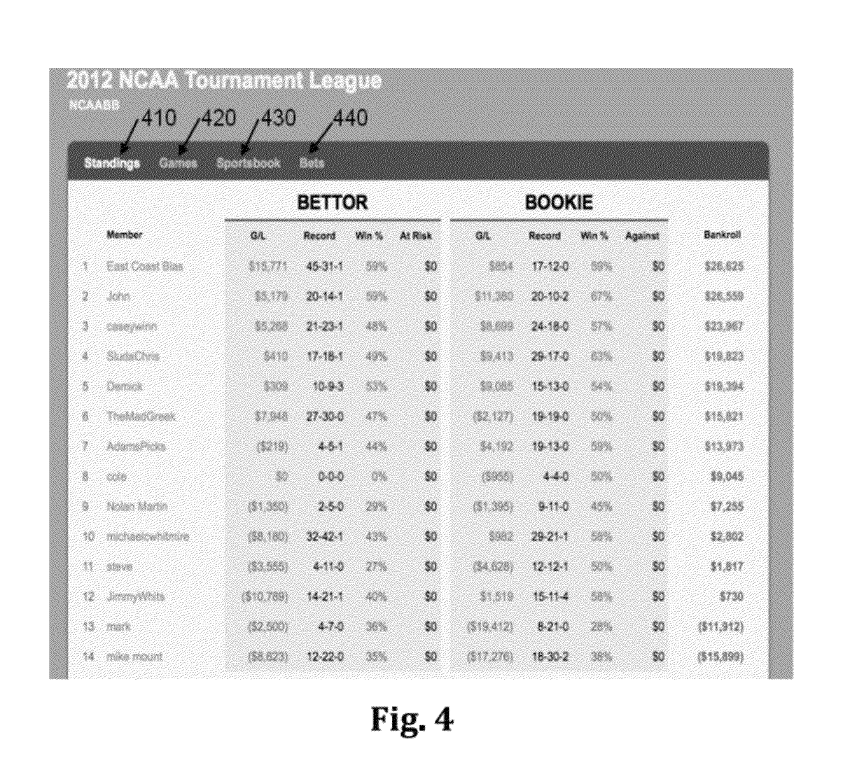

FIG. 4 is a screenshot showing an example of a typical league standings display. In this example a league for NCAA games is shown. The heading “Standings” (410) is highlighted to show that its display is active. “Games,”(420) “Sportsbook,” (430) and “Bets” (440) are other displays not within view, and refer to other details that may be made available for viewing by the participants. Separate bettor and bookie data is tracked in the table, and a total bankroll (450) shows each user net earnings or losses.

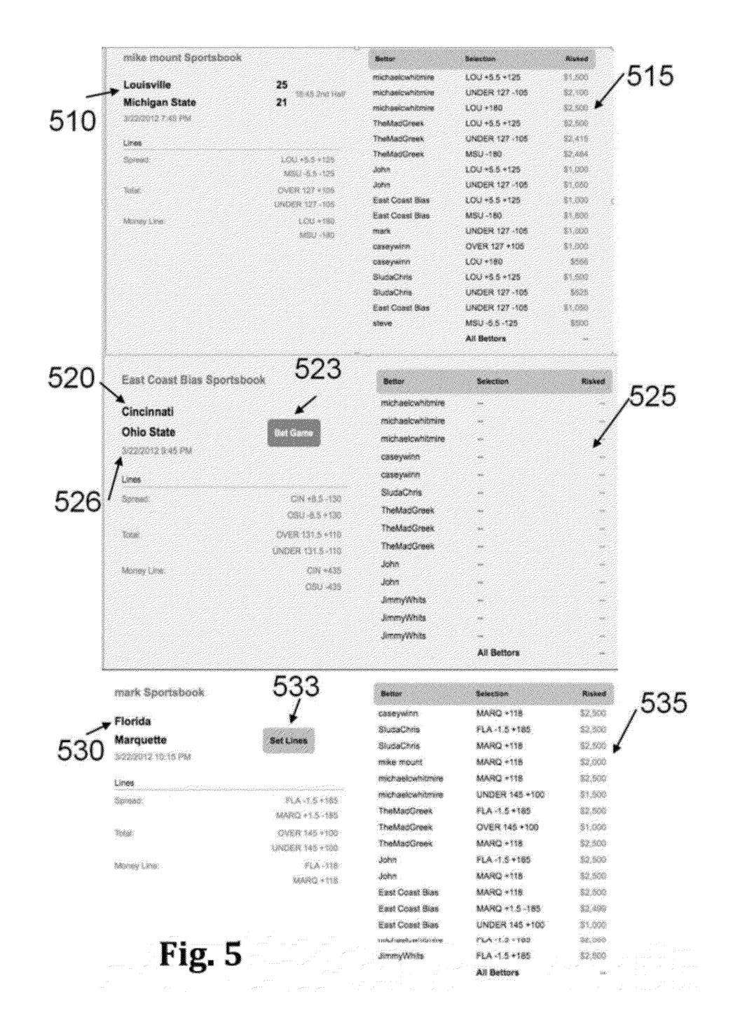

FIG. 5 is a screenshot showing another example of a typical league game display. This display in this screen shot is from the point of view of a user named “mark”. In this screenshot three games are listed chronologically according to the game's start time, but as would be clear to any one skilled in the art more games may be displayed to the user by scrolling down. The first game (510) is the Louisville versus Michigan State game. This game is currently in the second half, with the most recently updated remaining time and score are displayed. The bookie in this game is “mike mount”. Note that because this game has started the betting has closed and all league participants can view the wagers of all of the other league participants on the list of wagers (515).

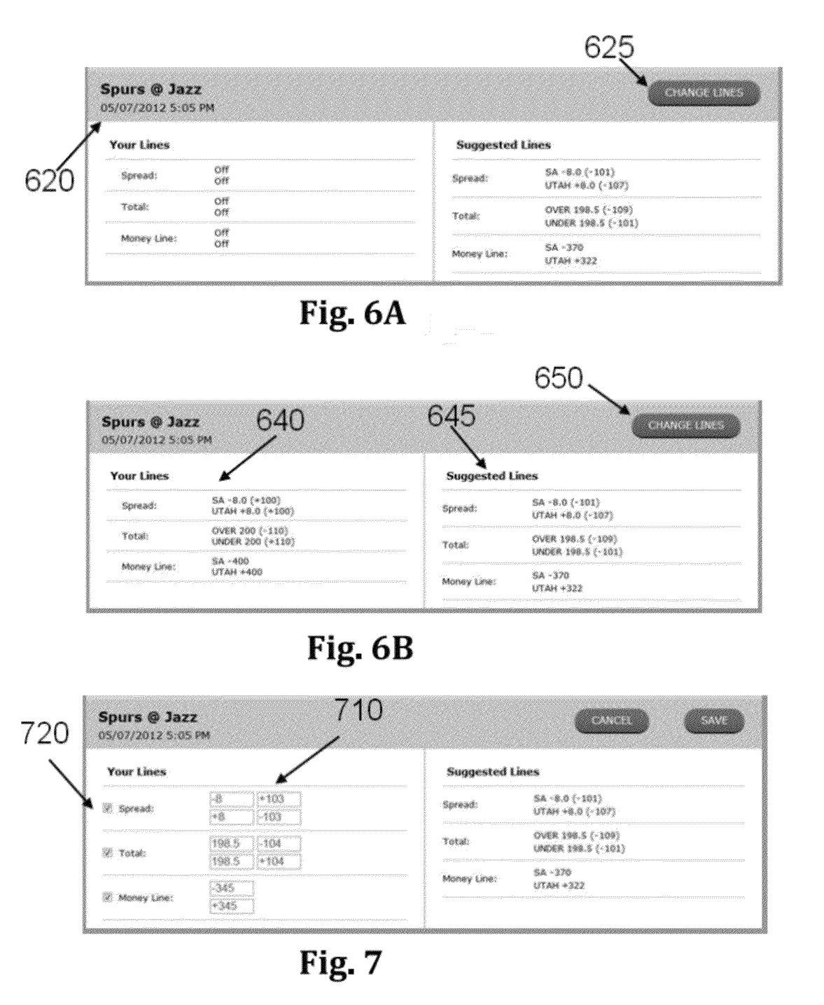

The second game on the list (520), the Cincinnati versus Ohio State game, is not underway. Thus the “Bet Game” button (523) is available and the betting is still open. The bookie in this game is “East Coast Bias”, the list of wagers (525) shows all the league participants which placed their bet but without reviling their actual bet. The Start time is displayed (526) so that league participants may be aware of when betting will be closed. The last game in the screenshot is Florida versus Marquette (530) and the bookie in this game is “mark”, the user to whom this screenshot is displayed. According to one embodiment although the game has not started “mark”, the bookie in this game, can view all wagers of the league participants. The bookie can than set the lines based on the list of wagers (535) by pressing the “Set Lines” button (533). Note that a “Bet Game” button is not available to the game's bookie. FIGS. 6A and 6B are two screenshots. FIG. 6A shows another typical league games display. This screenshot is taken under user any user who is the bookie for the Spurs Versus Jazz game (620). Whenever the “CHANGE LINES” button (625), the second screenshot displayed in FIG. 6B is opened. The second screenshot in FIG. 6B is an example of a typical bookie display. On the left of the screenshot (640) the most current or recent line, or the last line for the spread set by the user (who plays as the bookie), are presented. In this Example Spurs are favored to win by more than 8 point, with a moneyline of +100 (a Wager of 100 game points to win 100 game points, can also be written −100). Other moneylines for the game total and game's winner, or any other wagering item available may also be set by the bookie. On the right of the screenshot (645) “Suggested Lines” from a reputable odds maker are available to the user. The bookie may set the lines by clicking on the “CHANGE LINES” button (650).

FIG. 7 is a screenshot in a continuation of the scenario described in FIG. 6B. More specifically when the button “CHANGE LINES” (650) is clicked-on the screenshot of FIG. 7 may be displayed. As visible in the figure, data input fields (710) are available for bookies to adjust the lines and other values. Checkboxes (720) allow bookies to choose which lines are available for league participants to wager on. Also according to one embodiment, suggested lines are still viewable on the right. “CANCEL” and “SAVE” buttons allow the bookie to either save (retain, keep) or cancel (abandon) changes in the data input fields. In the example shown in FIG. 7 the line for the spread is changed from SPURS −8 (+100) in FIG. 6B to SPURS −8 (−103) in FIG. 7.

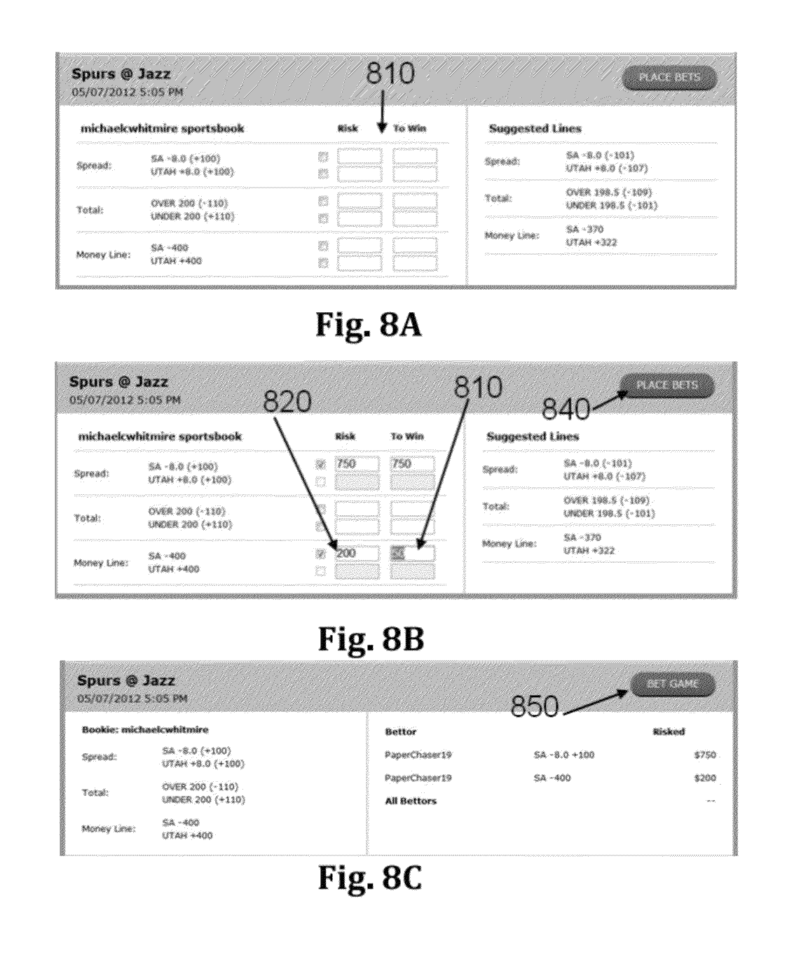

FIGS. 8A, 8B and 8C are screenshots illustrating how a user playing as a bettor can place his bets. As visible in the FIG. 8A, Data input fields (810) are available to the bettor to adjust his wagers. Each line or other wager item has two corresponding data input fields. In FIG. 8B, when a wager or numerical value is inserted in the left data input field (820), the right input field automatically shows what the bettor stands to win (830). According to a preferred embodiment the wager is not made official only by entering data into the data input fields. Entering data enables participants to experiment with the odds/moneylines. Preferably, a wager will be considered officially placed when the “PLACE BETS” button (840) is clicked-on. FIG. 8C is a screenshot of an official wager after a user has clicked on the “PLACE BETS” button, with all official wagers placed by users listed on the right. Note that the official wagers listed reflect the wager data inputted in FIG. 8B. The “BET GAME” button (850) takes the bettor back to the screenshot in FIG. 8A to place a new wager or experiment with odds.

1. A method for managing an interactive online website, the method comprising:
registering a plurality of users and storing data associated with each registered user that is accessible to by a server;
retrieving from one or more data sources information about coming sporting events;
providing registered users with at least some of the information retrieved;
receiving from a first user out of the plurality of registered users one or more lines associated with a coming sporting event;
receiving from each of at least additional two registered users other than the first user one or more wagers associates with the one or more lines received from the first user;
determining the results of the one or more wagers made by the at least two registered users based on the outcome of the sporting event; and
compensating the first user and/or the at least two users according to the determined results.

2. The method according to claim 1, further comprising establishing a user account for each registered user, and crediting each user upon registration with a predetermined number of game points in the user account.

3. The method according to claim 2, further comprising crediting/debiting the user account with game points of each registered user who place a wager on a specific sporting event, wherein said wager is based on a line set by the first user.

4. The method according to claim 2, further comprising crediting/debiting the user account of the first user based on wagers other registered users made on a line set by him.

5. The method according to claim 2, further comprising keeping a record of the game points earned when a registered user plays as a bookie, and providing a predetermined reward to the registered user that gained the most game points played as a bookie.

6. The method according to claim 1, further comprising selecting a first user out of the registered users to play as the bookie for at least one sporting event, wherein the first user selected cannot bet on the at least one sporting event in which he plays the bookie.

7. The method according to claim 1, further comprising receiving from a second user out of the registered users a second line associated with the coming sporting event, and wherein said registered users can select to place wagers on either the line associated with the first user or the second line associates with the second user.

8. The method according to claim 1, further comprising receiving from the first user out of the registered users one or more lines associated with a coming sporting event prior to the start of the coming sporting event.

9. The method according to claim 1, further comprising providing, close to real-time, the first user with information about the one or more wagers that each of at least two users made, thus enabling the first user to determine other lines based on the information provided.

10. A server hosting an interactive online gaming website, the server configured to:
retrieve from one or more data sources information about coming sporting events;
provide to a plurality of registered users with at least some of the information retrieved;
receive from a first user out of the plurality of registered users one or more lines associated with a coming sporting event;
publish the one or more lines received from the first user on the website;
receive from each of at least two registered users other than the first user one or more wagers associates with the one or more lines received from the first user;
determine the results of the wagers made by the at least two registered users based on the outcome of the sporting event; and
compensate the first user and/or the at least two users according to the determined results.

11. The server according to claim 10, further configured to create a user account for each registered user, and to credit each user upon registration with a predetermined number of game points.

12. The server according to claim 11, further configured to credit/debit the user account of each registered user who place a wager on a specific sporting event, wherein said wager is based on a line set by the first user.

13. The server according to claim 11, further configured credit/debit the user account of the first user based on wagers other registered users made on a line set by him.

14. The server according to claim 10, further configured to select a first user out of the registered users to play as the bookie for at least one sporting event, wherein the first user selected cannot bet on the at least one sporting event in which he plays the bookie.

15. The server according to claim 10, further configured to receive from a second user out of the plurality of registered users a second line associated with the coming sporting event, and wherein said plurality of registered users can select to place wagers on either the line associated with the first user or the second line associates with the second user.

16. The server according to claim 10, further configured to receive from the first user out of the registered users one or more lines associated with a coming sporting event prior to the start of the coming sporting event.

17. The server according to claim 10, further configured to provide, close to real-time, the first user with information about the one or more wagers that each of at least two users made, thus enabling the first user determining other lines based on the information provided.

18. The server according to claim 10, further configured to keep record of the game points earned when a registered user played as a bookie, and to determined which registered user gained the most game points as a bookie.

19. A non-transitory computer-readable medium storing one or more sequences of instructions which when loaded and executed by a computer system cause one or more processors to perform:
retrieving from one or more data sources information about coming sporting events;
providing to a plurality of registered users with at least some of the information retrieved;
receiving from a first user out of the registered users one or more lines associated with a coming sporting event;
publishing the one or more lines received from the first user on a website;
receiving from each of at least two registered users other than the first user one or more wagers associates with the one or more lines received from the first user;
determining the results of the one or more wagers made by the at least two registered users based on the outcome of the sporting event; and
compensating the first user and/or the at least two users according to the determined results.
